(19) United States
(12) Patent Application Publication
(10) Pub. No.: US 2026/0014595 A1
(43) Pub. Date: Jan. 15, 2026

(54) NOZZLE CLEANING MODULE OF BIDET

(71) Applicant: INUS Co., Ltd., Asan-si (KR)

(72) Inventors: Jong Won LEE, Bucheon-si (KR); Beom Seok SEO, Guri-si (KR); Min Gu KANG, Guri-si (KR)

(73) Assignee: INUS Co., Ltd., Asan-si (KR)

(21) Appl. No.: 19/268,537

(22) Filed: Jul. 14, 2025

(30) Foreign Application Priority Data
Jul. 15, 2024 (KR) 10-2024-0092785

(51) Int. Cl. B08B 3/12; B08B 3/02; E03D 9/08

(52) U.S. Cl. CPC B08B 3/12; B08B 3/02; E03D 9/08

(57) ABSTRACT

The present disclosure relates to a nozzle cleaning module of bidet that can thoroughly clean dirt inside and outside by vibrating a nozzle body with ultrasonic energy.

### CROSS-REFERENCE TO RELATED APPLICATION AND CLAIM OF PRIORITY

This application claims priority to Korean Patent Application No. 10-2024-0092785 filed on Jul. 15, 2024 in the Korean Intellectual Property Office (KIPO), the entire disclosure of which is incorporated by reference herein

### TECHNICAL FIELD

The present disclosure relates to a nozzle cleaning module of bidet that can thoroughly clean dirt inside and outside by vibrating a nozzle body with ultrasonic energy.

### BACKGROUND

In general, a bidet is a device that washes a user's genitals and anal area after defecation with washing water ejected through a nozzle by maintaining water temperature at a predetermined temperature according to a user's operation of the button, and provides warm air drying function to dry the moisture off the genitals and anal area with warm air, which is widely used in business, schools, lodging facilities, rest areas, public restrooms, and at home.

Since water used to wash the user's genitals and anal area is squirted upward from below, the water and fecal matter may drop onto the nozzle that the nozzle can be contaminated with fecal bacteria due to such water and stool, resulting in hygiene problems.

In order to solve such problem, water is sprayed onto the nozzle to remove debris. However, there still can be an unwashed area as water is not sprayed onto the bottom of the nozzle. Despite spraying a large amount of water, the nozzle could not be thoroughly washed off due to a weak water discharge speed. Furthermore, the nozzle that harbors bacteria can pose a risk of infection when it sprays contaminated water to cleanse the genital and anal areas.

To solve these problems, a known art device for cleaning a bidet nozzle is disclosed in Korean patent No. 10-2449010.

The device for cleaning a bidet nozzle as disclosed in the patent document, as shown in FIGS. 7, 8, and 9, comprises: a cover body 100 that is fixed to the tip of a nozzle base 10 inside a bidet and covers the surface of the nozzle sliding back and forth in the inner center by 360°; a closure cap 200 that is coupled to the front of the cover body 100 with an outer seal; and a discharge passage 300 that discharges water to the surface of the nozzle 20 being spaced apart at a distance between the cover body 100 and the closure cap 200. The tip of the discharge passage 300 is equipped with a first discharge inclined surface 310 inclined at a predetermined angle on the tip of the cover body 100, is equipped with a second discharge inclined surface 320 at an angle corresponding to the first discharge inclined surface 310 inner surface of the closure cap 200, and is further equipped with a discharge guide surface 400 that guides water while forming a clearance C wider than the discharge passage 300 between the first discharge inclined surface 310 and the second discharge inclined surface 320.

The discharge passage 300 has a clearance smaller than a supply path 140 of the cover body 100 to increase the discharge speed of water; is formed radially at the tip of the cover body 100; further has a vertical discharge opening that washes the nozzle 20 surface as water is discharged orthogonally to the direction of the nozzle 20; is formed radially inner surface of the closure cap 200; and it may be further equipped with a groove 600 designed to direct the flow of water, which enhances the cleaning power of a certain portion of the nozzle 20.

According to the prior art conventional device for cleaning nozzles, since the cover body through which water flows in is configured to surround the outer peripheral surface of the nozzle 20 by 360°, it enhances the cleaning power of the nozzle surface, and as the discharge passage has a smaller clearance than the supply passage that the discharge speed of water is increased, enabling thorough cleaning with a small amount of water.

In addition, according to the prior art conventional device for cleaning nozzles, a groove designed to direct the flow of water is formed to maximize the cleaning power of a certain portion of the nozzle.

However, there are limits to cleaning the nozzle 20 by spraying it with water. That is, debris stuck to the nozzle surface may adhere tightly and not easily fall off when sprayed.

In particular, debris that entered inside through the vent hole formed in the bottom surface of the nozzle 20 cannot be removed by simply cleaning the surface of the nozzle.

### PRIOR ART DOCUMENT

### Patent Document

(Patent Document 1) Korean Patent No. 10-2449010 (published on Sep. 26, 2022)

### SUMMARY

The present disclosure has been made to solve the above-described problem, and an object thereof is to provide a nozzle cleaning module of bidet that can directly vibrate the nozzle body with ultrasonic energy to remove and clean debris on the exterior and interior.

To achieve the foregoing objectives, the nozzle cleaning module of bidet according to the present disclosure is installed on the bidet body so that it can move back and forth, and it includes a washing nozzle having a vent hole and a washing spray port on the top and bottom of the front side, and an ultrasonic vibrator attached to an outer surface of the nozzle to vibrate and clean the washing nozzle with the ultrasonic vibrator's ultrasonic energy.

The nozzle cleaning module of bidet according to the present disclosure provides the following.

The ultrasonic vibrator is directly installed on an outer surface of the washing nozzle to clean the interior and exterior by vibrating the nozzle with ultrasonic energy.

Additionally, it can contribute to visualization by intensively cleaning the washing spray port of the washing nozzle with water sprayed from the cleaning spray tip, as it is attached to the bidet body.

In addition, since the diameter of the cleaning spray port of the cleaning spray tip is smaller than that of the water inlet of the cleaning spray tip, debris can be thoroughly removed by injecting a water jet.

### BRIEF DESCRIPTION OF THE DRAWINGS

FIG. 1 and FIG. 2 are perspective views of the nozzle cleaning module of bidet in accordance with an exemplary embodiment of the present disclosure, which is installed on the bidet body to be able to move automatically back and forth.

FIG. 3 is a perspective view of a nozzle cleaning module shown in FIG. 2.

FIG. 4 illustrates a side sectional view of FIG. 3.

FIG. 5 is a perspective view of a cleaning spray tip of FIG. 2.

FIG. 6 illustrates a side sectional view of FIG. 5.

FIG. 7 is an exploded perspective view of a conventional nozzle cleaning device of bidet.

FIG. 8 illustrates an assembled cross-sectional view of FIG. 7.

FIG. 9 illustrates a close-up cross sectional view illustrating a principal part of FIG. 8.

### DETAILED DESCRIPTION OF THE EMBODIMENTS

Hereinafter, preferred embodiments of the present disclosure will be described in detail in conjunction with the accompanying drawings. It should be understood that the terms and words used in the present disclosure and appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto at the time the present application was filed without departing from the spirit and scope of the disclosure.

In addition, like reference numerals are used to designate the same portions as are included in the prior art, and similar detailed description is therefore omitted.

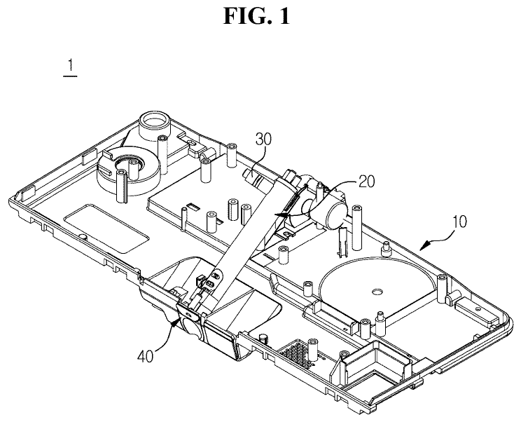

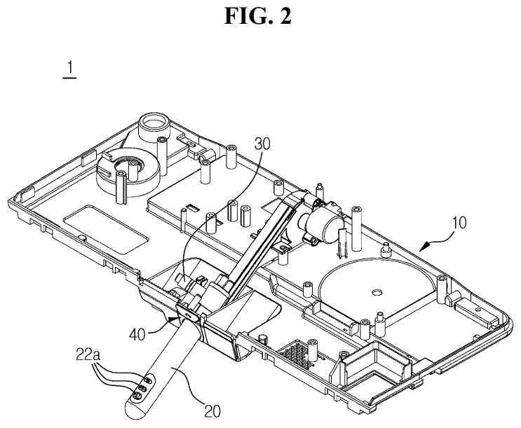

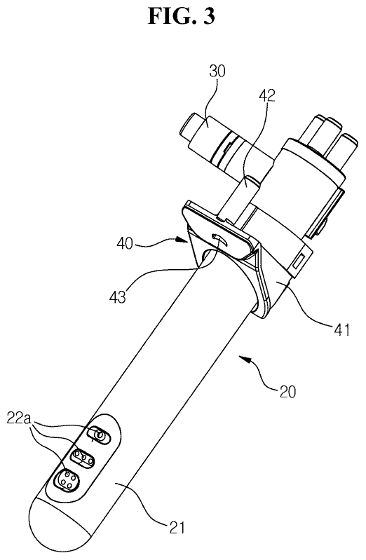

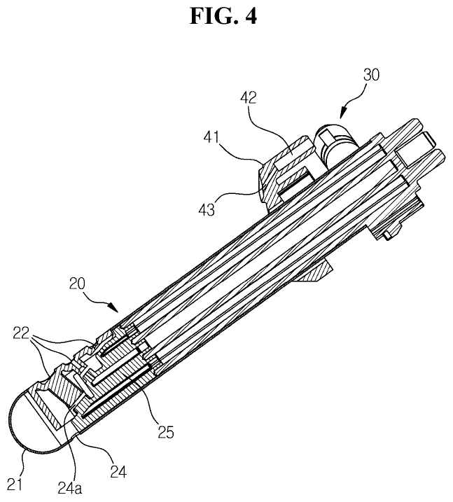

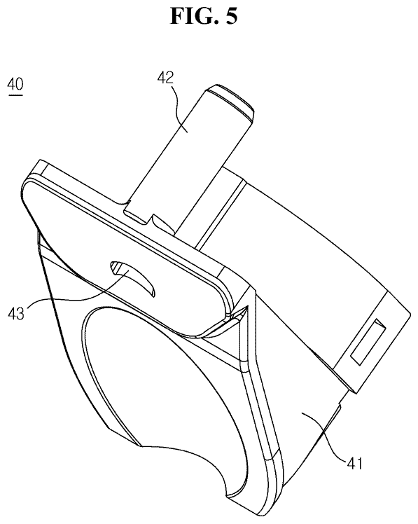

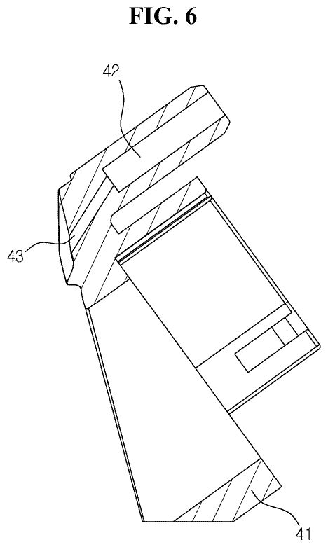

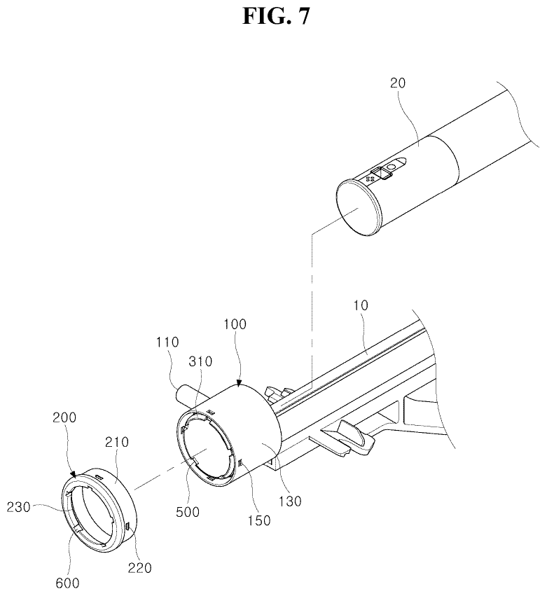

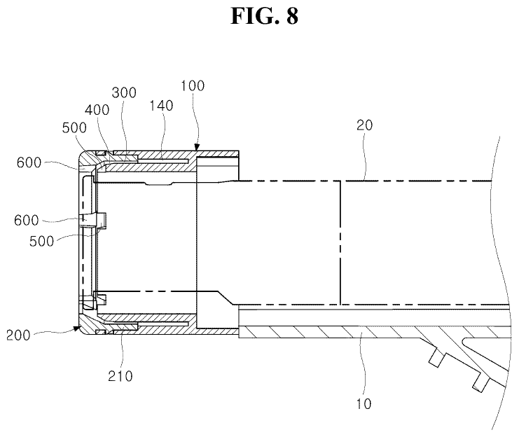

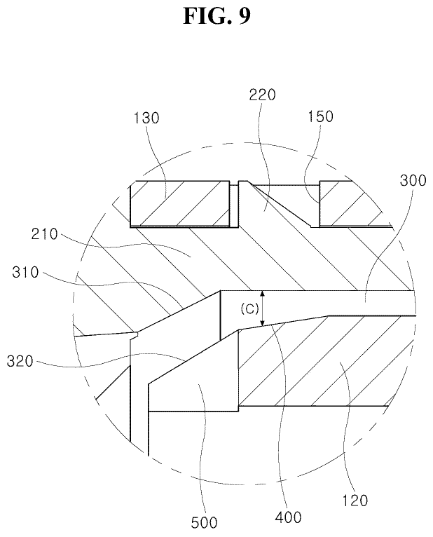

FIGS. 1 and 2 are perspective views of the nozzle cleaning module of bidet in accordance with an exemplary embodiment of the present disclosure, which is installed on the bidet body to be able to move automatically back and forth. FIG. 3 is a perspective view of a nozzle cleaning module shown in FIG. 2. FIG. 4 illustrates a side sectional view of FIG. 3. FIG. 5 is a perspective view of a cleaning spray tip of FIG. 2. FIG. 6 illustrates a side sectional view of FIG. 5.

FIGS. 1 and 2 are perspective views of a nozzle cleaning module of bidet in accordance with an exemplary embodiment of the present disclosure, which is installed on the bidet body to move automatically back and forth.

Referring to FIGS. 1 and 2, the nozzle cleaning module of bidet 1 according to the present disclosure may include a bidet body 10, a washing nozzle 20 that is movably installed on the bidet body 10, and an ultrasonic vibrator 30 attached to the washing nozzle 20.

The bidet body 10 can be fixed to the toilet body (not shown). The parts required for washing and bidet, cleaning and drying, can be mounted inside the bidet body 10.

FIG. 3 is a perspective view of the nozzle cleaning module shown in FIG. 2. FIG. 4 illustrates a side sectional view of FIG. 3.

Referring to FIGS. 3 and 4, the washing nozzle 20 can include a test tube-shaped washing nozzle tube 21 with a closed front end. A washing spray hole 22 and a vent hole 24 can be formed at the top and bottom surface of the front area of the washing nozzle tube 21. An insert 25 for washing spray can be inserted into the washing nozzle tube 21. A washing spray port 22a disposed in the washing spray hole 22 and a drain 24a vented to a vent hole 24 can be formed in the insert 25 for washing spray.

As shown in FIG. 3, an ultrasonic vibrator 30 can vibrate an object by generating ultrasonic waves. The ultrasonic vibrator 30 can be attached to the outer surface of the washing nozzle 20. The ultrasonic vibrator 30 can remove debris, especially stubborn dirt or large dirt, from the outer surface of the washing nozzle tube 21 by vibrating the washing nozzle 20. In addition, dirt that is permeated into the washing nozzle tube 21 can be removed by vibration to be discharged into the vent hole 24. The intensity of ultrasonic energy of the ultrasonic vibrator 30 can be adjusted in accordance with the use status.

FIG. 5 is a perspective view of a cleaning spray tip of FIG. 2. FIG. 6 illustrates a side sectional view of FIG. 5.

Meanwhile, when it is washed only by the ultrasonic vibrator 30 it may not be visualized that a user may have little confidence as to whether it is thoroughly cleaned or not.

To solve this problem, the nozzle cleaning module 1 according to embodiments can further include a cleaning spray tip 40. The cleaning spray tip 40 can wash the washing spray port 22a. The cleaning spray tip 40, as shown in FIGS. 1 and 2, can be installed in the center of the front side of the bidet body 10.

Referring to FIGS. 5 and 6, the cleaning spray tip 40 can include a hollow cleaning spray body 41. The hollow cleaning spray body 41 can be installed on the bidet body 10. The washing nozzle 20 can be movably inserted centrally in the hollow cleaning spray body 41.

The cleaning spray tip 40 can include a water inlet 42. The water inlet 42 allows water to flow into the washing nozzle 20. The water inlet 42 can have a shape of a pipe protruding from the upper portion of the rear side of the hollow cleaning spray body 41 to rearward. The water inlet 42 can be arranged parallel to the longitudinal direction of the washing nozzle 20 as shown in FIG. 4.

The cleaning spray tip 40 can include the cleaning spray port 43. The cleaning spray port 43 can be formed on the hollow cleaning spray body 41 so that it communicates with the water inlet 42. The cleaning spray port 43 may be inclined toward the outer surface of the washing nozzle 20. That is, as shown in FIG. 4, the cleaning spray port 43 may be inclined toward the outer surface of the washing nozzle 20 at an outlet of the water inlet 42. Due to inclination, water can strongly hit the outer surface of the washing nozzle tube 21, the washing spray port 22a, and the washing spray hole 22.

In addition, the diameter of the cleaning spray port 43 can be formed to be smaller than that of the water inlet 42. Due to such difference in diameter, cleaning efficacy can be improved greatly.

Some embodiments or other embodiments of the present disclosure described above are not mutually exclusive or distinct from each other. Configurations or functions of some embodiments or other embodiments of the present disclosure described above can be used together or combined with each other.

It is apparent to those skilled in the art that the present disclosure can be embodied in other specific forms without departing from the spirit and essential features of the present disclosure. Accordingly, the above detailed description should not be construed as limiting in all aspects and should be considered as illustrative. The scope of the present disclosure should be determined by rational interpretation of the appended claims, and all modifications within an equivalent scope of the present disclosure are included in the scope of the present disclosure.

[Description of Reference Numerals]

| | |
|---|---|
| 1: nozzle cleaning module of bidet | 10: bidet body |
| 20: washing nozzle | 21: washing nozzle tube |
| 22: washing spray hole | 22a: washing spray port |
| 24: vent hole | 24a: drain |
| 30: ultrasonic vibrator | 40: cleaning spray tip |
| 41: hollow cleaning spray body | 42: water inlet |
| 43: cleaning spray port | |

What is claimed is:

1. An nozzle cleaning module of bidet comprising:
a washing nozzle tube installed on a bidet body to be able to move back and forth;
a washing nozzle having a vent hole and a washing spray port on the top and bottom of the front side of the washing nozzle tube;
a ultrasonic vibrator attached to an outer surface of the washing nozzle to vibrate and clean the washing nozzle using the ultrasonic vibrator's ultrasonic energy,
wherein a cleaning spray tip is installed on the bidet body to clean the washing spray port,
and the washing nozzle is movably inserted centrally in the cleaning spray tip,
and the cleaning spray tip is installed on the bidet body;
wherein the cleaning spray tip comprises
a hollow cleaning spray body into which the washing nozzle is inserted,
a water inlet arranged parallel to the longitudinal direction of the washing nozzle and formed at the upper portion of the rear side of the hollow cleaning spray body, and
a cleaning spray port that cleans the washing spray port inclined toward the outer surface of the washing nozzle at an outlet of the water inlet, being formed in the hollow cleaning spray body so that it communicates with the water inlet
wherein the diameter of the cleaning spray port is smaller than that of the water inlet.
